(19) United States
(12) Patent Application Publication
(10) Pub. No.: US 2025/0093254 A1
(43) Pub. Date: Mar. 20, 2025

(54) SYSTEMS AND METHODS FOR SPECTROSCOPIC MEASUREMENTS OF INHOMOGENEOUS MIXTURES

(71) Applicant: Tornado Spectral Systems Inc., Mississauga (CA)

(72) Inventors: Bradford B. Behr, Silver Spring, MD (US); Aaron Phillip Weinroth, Thornhill (CA); Shaun Fraser, Etobicoke (CA)

(21) Appl. No.: 18/728,358

(22) PCT Filed: Jan. 12, 2023
(86) PCT No.: PCT/CA2023/050031

§ 371 Date: Jul. 11, 2024

Related U.S. Application Data
(60) Provisional application No. 63/298,853, filed on Jan. 12, 2022.

(51) Int. Cl. G01N 15/1434; G01N 15/14; G01N 15/1429

(52) U.S. Cl. CPC G01N 15/1434; G01N 15/1429; G01N 2015/1493

(57) ABSTRACT

Methods and systems are described for performing spectroscopic measurement of at least one analyte of interest in an inhomogeneous sample using a spectroscopic system. This generally involves generating and aiming an illumination beam which forms a focal region having focal region size S upon a surface or within a volume of the sample where there is relative motion between the sample and the focal region at a relative speed V; selecting a desired ratio between an exposure time E for a detector of the spectroscopic system and a transit time T for a particle of the at least one analyte of interest to traverse the focal region; acquiring one or more spectral data sets corresponding to spectra for a region of the sample within the focal region; and analyzing the one or more spectral data sets to generate one or more corresponding analytical results.

### CROSS-REFERENCE TO RELATED PATENT APPLICATION

This application claims the benefit of U.S. Provisional Patent Application No. 63/298,853 filed Jan. 12, 2022; the entire contents of U.S. Provisional Patent Application No. 63/298,853 is hereby incorporated herein in its entirety.

### FIELD

Various embodiments are described herein that generally relate to the field of optical spectroscopy and more specifically relate to methods for improved detection and quantification of particles in an inhomogeneous mixture of solids, liquids, and/or gases when using various spectroscopic methods such as Raman spectroscopy, for example.

### BACKGROUND

Raman spectroscopy is a powerful analytic technique which can determine the chemical composition of a sample by measuring the wavelength shift of monochromatic light scattered by molecules of the sample. A typical Raman spectroscopic analyzer illuminates a sample of interest with a laser, captures a portion of the light scattered from the sample, and performs spectral analysis of the scattered light returning to the apparatus from the illuminated region of the sample. A small fraction of the laser photons will be shifted in wavelength (to either longer or shorter wavelengths) by interactions with the functional groups of the sample molecules, with the amount of “Raman shift” being highly specific to the molecules of the sample in question. The spectrum of the scattered light, as measured by a Raman spectrometer device, therefore shows peaks or bands at specific locations which can be used to identify which molecular species are present in the sample. Furthermore, with appropriate calibration, the heights of these Raman spectral peaks can be used to determine the quantitative proportions of each chemical component of a sample, such as a mixture, including the chemical components of interest (hereafter referred to as the “analytes”). The Raman technique can be used on molecular analytes in many different physical forms: solids, liquids, slurries, gases, or combinations thereof. The measured Raman spectral range typically includes the so-called “fingerprint region” of 200 to 1800 cm⁻¹ and the “CH stretch region” of 2700 to 3300 cm⁻¹, where the wavenumber unit “inverse centimeters” or cm⁻¹ is commonly used to quantify the amount of Raman shift from the laser wavelength used to excite the target molecules in the sample.

Due to the fact that the Raman scattering mechanism sends scattered photons randomly in all directions, the strongest Raman signals are detected when the illuminating laser beam is focused down to a small spot on or within the sample, the focal spot typically being about 5 to 500 μm in diameter. The distribution of Raman-shifted photons returning to the Raman spectroscopic analyzer (also known as a Raman spectrometer) therefore only represents the chemical composition present within this small focal region. If the analyte mixture is homogeneous, then the small focal region is representative of the mixture at large, and the results of the Raman analysis can be safely interpreted to apply to the entire sample. However, if the sample is inhomogeneous, which may occur when the sample comprises a mixture of distinct chemicals, analytes, or particles that have not fully blended together, then the Raman measurements of a small focal region may not accurately reflect the chemical properties of the sample as a whole.

In some cases, better representative measurement of such mixtures can be achieved by illuminating a larger region (more than 500 μm in diameter) with the laser, although this approach will often reduce the strength of the Raman signal (because a smaller fraction of randomly scattered photons are within the range of angles which can be collected by the optical probe apparatus and transmitted to the Raman spectrometer) and thus lead to lower quality measurement due to various noise sources. Furthermore, a larger illumination region also sacrifices spatial resolution, such that information about the spatial size of the inhomogeneities in the sample is lost.

An alternative approach which maintains strong Raman signal is to use a small focal spot size but also cause the sample mixture to move relative to the focal spot region, either by flowing the sample mixture past a fixed focal spot region or scanning the focal spot region over or through a fixed sample or causing both the sample and the focal spot to be in motion. The acquisition of spectral data may be either continuous (with a single uninterrupted exposure or series of exposures) or discrete (with temporal gaps between exposures). Similarly, the sample motion or focal spot scanning may be either continuous (with uninterrupted motion in substantially the same direction and speed) or discrete (jumping from one position to another or changing direction and speed). If the Raman spectrum is collected over an extended period of time (either with a single long exposure of the light-detecting device inside the Raman spectrometer, such as a camera, or by averaging or summing multiple exposures together), then the resulting Raman spectrum will represent the average chemical composition of the sample region over which or through which the focal spot traveled during the extended time period. The extended time period may be of any duration (typically between 30 milliseconds and 10 minutes, but shorter or longer durations are also possible), and the resulting extended sample region may vary in size typically between about 1 millimeter and 100 meters but may include sizes smaller than about 1 millimeter or larger than about 100 meters.

In some applications with an inhomogeneous mixture, however, it may be desirable to use the Raman measurements to detect a small quantity of one or more specific analytes which each occupies only a small percentage of the mixture by volume, for instance 10% (100,000 ppm) to 0.0001% (1 ppm). These trace analytes will typically take the form of small particles, and the terms “analyte”, “particle”, and “analyte particle” are used interchangeably herein to describe these trace analytes. By way of example, these analyte particles may come in many different forms or types as follows hereafter such as but not limited to, grains of sand or rock, for example, which are contaminating a large volume of sugar or salt crystals. In other instances, the analyte particles may be tiny pieces of plastic (5 mm to 0.1 μm in diameter) which are present in a water sample. For both of these examples, the particles are an undesirable part of the sample mixture, and the Raman measurements may be used to determine whether the contaminants are present in a large enough quantity to create a safety or health issue.

In yet another example, the analyte particles may be a desirable part of the sample mixture, such as particles of an active pharmaceutical compound in an excipient matrix which need to be present at some specified “drug load” level to have the correct medicinal impact when the sample mixture is administered to a patient. In some cases, all the analyte particles will be of the same type and in other cases there may be analyte particles of more than one type. Although conventional Raman methods can detect certain analyte particles in these sorts of applications, these conventional methods may only be effective in cases where the analyte particle concentration is relatively high (for instance, occupying 1% or more of the sample volume), and the conventional methods fail at lower concentrations for a variety of reasons as detailed below, making reliable spectroscopic measurements problematic.

When the analyte particles of interest are present at a low concentration, acquiring an average Raman spectrum over an extended sample region as described above may not be desirable, as the Raman peaks or bands of the low-concentration analyte particles can be obscured or hidden by the stronger Raman peaks or bands of the other constituents of the sample mixture. Furthermore, the other constituents of the sample mixture may fluoresce when illuminated by the laser source, causing a strong broadband emission across most or all of the spectral range of the Raman analyzer spectrometer, further diluting the Raman signal from the low-concentration analyte particles, and making it difficult (if not impossible) to detect or quantify the low-concentration analyte particles using the averaged Raman spectra.

Similar limitations may also be relevant for spectroscopic modalities other than Raman spectroscopy, such as, but not limited to, broadband ultraviolet spectroscopy, visible spectroscopy, near-infrared spectroscopy, infrared spectroscopy, fluorescence spectroscopy, or laser induced breakdown spectroscopy, in which an illumination beam may be directed upon a sample over a large extended area or a smaller focused spot, and a resulting tradeoff between area or volume coverage and sensitivity may result.

### SUMMARY OF VARIOUS EMBODIMENTS

According to one aspect of the teachings herein, there is provided at least one embodiment of a method for performing spectroscopic measurement of at least one analyte of interest in an inhomogeneous sample using a spectroscopic system, wherein the method comprises: generating and aiming an illumination beam which forms a focal region having a focal region size S upon a surface of the sample or within a volume of the sample where there is relative motion between the sample and the focal region at a relative speed V; selecting a desired ratio between the exposure time E for a detector of the spectroscopic system and a transit time T for a particle of the at least one analyte of interest to traverse the focal region; acquiring one or more spectral data sets corresponding to one or more spectra for a region of the sample within the focal region; and analyzing the one or more spectral data sets to generate one or more corresponding analytical results.

In at least one embodiment, selecting the desired ratio between the exposure time E and the transit time T comprises selecting: (i) an exposure time E for a detector of the spectroscopic system, (ii) the relative speed V, (iii) the focal region size S, or (iv) any combination thereof by configuring one or more elements of the spectroscopic system.

In at least one embodiment, the method comprises determining a relative proportion of the at least one analyte of interest in the sample mixture via a statistical analysis of the one or more analytical results.

In at least one embodiment, the exposure time E of the detector is in a range of about one tenth of the transit time T to about ten times the transit time T.

In at least one embodiment, the exposure time E of the detector is selected to be substantially equal the transit time T.

In at least one embodiment, the method comprises maintaining the focal region in a stationary position while the sample is moving past the focal region at the relative speed V, maintaining the sample in a stationary position and moving the focal region across or through the sample at the relative speed V or maintaining both the sample and the focal region in motion to produce the relative speed V.

In at least one embodiment, the method comprises maintaining the focal region in a stationary position while the sample is moving past the focal region at the relative speed V.

In at least one embodiment, the method comprises maintaining the sample in a stationary position and moving the focal region across or through the sample at the relative speed V.

In at least one embodiment, both the sample and the focal region move relative to one another at the relative speed V.

In at least one embodiment, the method comprises: (a) estimating, measuring, or selecting a value for particle size P; and/or (b) estimating, measuring or selecting the relative speed V for achieving the desired ratio between the exposure time E and the transit time T.

In at least one embodiment, the method comprises varying at least one measurement parameter including: (a1) the exposure time E; (b1) the focal region size S; (c1) the relative speed V; or (d1) any combination of (a1) to (c1) by gradually increasing or decreasing the at least one measurement parameter to obtain a plurality of spectral data sets, evaluating an intensity of particle detections for each of the plurality of spectral data sets, and then selecting a desired value for the at least one measurement variable that produces a maximum intensity of distinct particle detections, a maximum rate of distinct particle detections, or more consecutive double detections than consecutive triple detections for the at least one analyte particle of interest.

In at least one embodiment, the method comprises measuring the relative speed V and adjusting the exposure time E and/or the relative speed V so that the exposure time E is substantially equal to the transit time T or within the range of about one tenth of to about ten times the transit time T of the at least one analyte particle.

In at least one embodiment, the method comprises measuring a particle size P of the at least one analyte particle and adjusting the exposure time E and/or the relative speed V so that the exposure time E is substantially equal to the transit time T or within the range of about one tenth of to about ten times the transit time T of the at least one analyte particle.

In at least one embodiment, the method comprises measuring the relative speed V and a particle size P of the at least one analyte particle and adjusting the exposure time E and/or the relative speed V so that the exposure time E is substantially equal to the transit time T or within the range of about one tenth of to about ten times the transit time of the at least one analyte particle.

In at least one embodiment, the method comprises gradually increasing or decreasing the exposure time E and evaluating an intensity of particle detections for each of the plurality of spectral data sets, and then selecting a preferred exposure time E which is the exposure time that produces a maximum intensity or a maximum rate of distinct particle detections for the at least one analyte particle of interest.

In at least one embodiment, the preferred exposure time is the exposure time E that results in more consecutive double detections than consecutive triple detections of the at least one analyte particle of interest being detected or counted as a single unique analyte particle.

In at least one embodiment, the analysis of each spectral data set is performed to detect a presence and/or concentration of the at least one analyte of interest in the sample.

In at least one embodiment, the analysis of each spectral data set involves performing a univariate measurement, using a multivariate algorithm, or fitting the spectral data set with a theoretical curve or peak profile which represents a spectral signature of the at least one analyte of interest.

In at least one embodiment, the statistical analysis of the set of analytical results comprises performing a running average, a Student's t-distribution, or a Kolmogorov-Smirnov distribution analysis.

In at least one embodiment, a number N of spectral data sets are acquired so that the statistical analysis is performed for a desired statistical confidence limit.

In at least one embodiment, the method comprises using optical instrumentation that is configured to obtain and process light scattered from the sample for exposure times between about 10 to about 100 milliseconds.

In at least one embodiment, the method comprises using optical instrumentation that has a collection efficiency of about 1% to about 50% of one or more light beams scattered from the sample.

In at least one embodiment, the method comprises using optical instrumentation that has an optical efficiency of about 10% to about 90%.

In at least one embodiment, the method comprises using optical instrumentation that has continuous-wave lasers with power from about 100 to about 5000 mW or pulsed lasers which have a pulse duration of about 1 ps to about 1 ms at an energy of about 1 μJ to about 10 mJ per pulse.

In at least one embodiment, the spectroscopic system is configured to perform Raman spectroscopy, broadband ultraviolet spectroscopy, visible spectroscopy, near-infrared spectroscopy, infrared spectroscopy, fluorescence spectroscopy, or laser induced breakdown spectroscopy.

In accordance with another aspect of the teachings herein, there is provided at least one embodiment of a spectroscopic system for performing spectroscopic measurement of at least one analyte of interest in an inhomogeneous sample, wherein the system comprises: a light source for generating an illumination beam; a sample measurement apparatus that is optically coupled to the light source for transmitting the illumination beam to form a focal region having a focal region size S upon a surface of the sample or within a volume of the sample where the sample and the focal region move relative to one another at a relative speed V; a spectrometer that is optically coupled to the sample measurement apparatus for receiving light that is scattered, reflected, or emitted from the sample in response to the illumination beam; and a computing device that includes at least one processor that is configured to execute software instructions causing the computing device to perform the spectroscopic measurement by: selecting a desired ratio between an exposure time E for a detector of the spectrometer and a transit time T for a particle of the at least one analyte of interest to traverse the focal region; acquiring one or more spectral data sets for a region of the sample within the focal region; and analyzing the one or more spectral data sets to generate one or more corresponding analytical results.

In at least one embodiment, the computing device is configured to determine a relative proportion of the at least one analyte of interest in the sample mixture via a statistical analysis of the one or more analytical results.

In at least one embodiment, the computing device configures the spectroscopic system such that the exposure time E of the detector is in a range of about one tenth of the transit time T to about ten times the transit time T.

In at least one embodiment, the computing device configures the spectroscopic system such that the exposure time E of the detector is substantially equal to the transit time T.

In at least one embodiment, the sample measurement apparatus is adapted to maintain the focal region in a stationary position and the sample is provided in a flow channel allowing the sample to move past the focal region at the relative speed V.

In at least one embodiment, the sample measurement apparatus is adapted to maintain the focal region in a stationary position and the sample is provided in a flow channel allowing the sample to move past the focal region at the relative speed V, the sample is in a stationary position and the sample measurement apparatus is adapted to move the focal region across the sample at the relative speed V or the sample measurement apparatus is adapted to move both the sample and the focal region to produce the relative speed V.

In at least one embodiment, the sample is in a stationary position and the sample measurement apparatus is adapted to move the focal region across the sample at the relative speed V.

In at least one embodiment, the sample measurement apparatus is adapted to move both the sample and the focal region relative to one another at the relative speed V.

In at least one embodiment, wherein the computing device is configured to estimate, measure, or select a particle size P; and/or estimate, measure or select the relative speed V for achieving the desired ratio between the exposure time E and the transit time T.

In at least one embodiment, the computing device is configured to vary at least one measurement parameter including: (a) the exposure time E; (b) the focal region size S; (c) the relative speed V; or (d) any combination of (a) to (c) by gradually increasing or decreasing the at least one measurement parameter to obtain a plurality of spectral data sets, evaluate an intensity of particle detections for each of the plurality of spectral data sets, and then select a desired value for the at least one measurement variable that produces a maximum intensity of distinct particle detections, a maximum rate of distinct particle detections, or more consecutive double detections than consecutive triple detections for the at least one analyte particle of interest.

In at least one embodiment, the system comprises a motion sensor to obtain movement data for the relative motion between the sample and the focal region and the computing device is configured to measure the relative speed V from the movement data and adjust the exposure time E and/or the relative speed V so that the exposure time E is substantially equal to the transit time T or within the range of about one tenth of to about ten times the transit time T of the at least one analyte particle.

In at least one embodiment, the system comprises a measurement sensor to obtain measurement data for a particle size P of the at least one analytical particle and the computing device is configured to measure the particle size P from the measurement data and adjust the exposure time E and/or the relative speed V so that the exposure time E is substantially equal to the transit time T or within the range of about one tenth of to about ten times the transit time T of the at least one analyte particle.

In at least one embodiment, the system comprises one or more sensors for measuring movement data for the relative motion between the sample and the focal region and measurement data for a particle size P of the at least one analytical particle and the computing device is configured to measure the relative speed V and the particle size P of the at least one analytical particle from the movement data and measurement data and adjust the exposure time E and/or the relative speed V so that the exposure time E is substantially equal to the transit time T or within the range of about one tenth of to about ten times the transit time T of the at least one analyte particle.

In at least one embodiment, the computing device is configured to gradually increase or decrease the exposure time E and evaluate an intensity of particle detections for each of the plurality of spectral data sets, and then select a preferred exposure time E which is the exposure time that produces a maximum intensity or a maximum rate of distinct particle detections for the at least one analyte particle of interest.

In at least one embodiment, the computing device is configured to perform the analysis of each spectral data set to detect a presence and/or concentration of the at least one analyte of interest in the sample.

In at least one embodiment, the spectrometer is configured to obtain and process light scattered from the sample for exposure times between about 10 to 100 milliseconds.

In at least one embodiment, the system comprises optical instrumentation that has a collection efficiency of about 1% to about 50% of one or more light beams scattered from the sample.

In at least one embodiment, the system comprises optical instrumentation that has an optical efficiency of about 10% to about 90%.

In at least one embodiment, the system comprises optical instrumentation that has continuous-wave lasers with power from about 100 to about 5000 mW or pulsed lasers which have a pulse duration of about 1 ps to about 1 ms at an energy of about 1 μJ to about 10 mJ per pulse.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 shows an example embodiment of a Raman spectrometry system that may be used for spectroscopic measurements of inhomogeneous mixtures.

FIG. 2A shows an example embodiment of a sample measurement apparatus that can be used with the system of FIG. 1 where an inhomogeneous sample is being illuminated by a light beam and the sample is moving relative to a stationary beam.

FIG. 2B shows another example embodiment of a sample measurement apparatus that can be used with the system of FIG. 1 where an inhomogeneous sample is being illuminated by a light beam and the light beam is moving and the inhomogeneous sample is stationary.

FIG. 2C shows another example embodiment of a sample measurement apparatus that can be used with the system of FIG. 1 where an inhomogeneous sample is being illuminated by a light beam and the light beam and sample are both moving.

FIG. 3A shows a flow chart of an example embodiment of a method for spectroscopic measurements of inhomogeneous mixtures.

FIG. 3B shows a flow chart of another example embodiment of a method for spectroscopic measurements of inhomogeneous mixtures.

FIG. 4 shows another example embodiment of a Raman spectrometry system that may be used for spectroscopic measurements of inhomogeneous mixtures.

Further aspects and features of the example embodiments described herein will appear from the following description taken together with the accompanying drawings.

### DETAILED DESCRIPTION OF THE EMBODIMENTS

Various embodiments in accordance with the teachings herein are described to provide an example of at least one embodiment of the claimed subject matter. No embodiment described herein limits any claimed subject matter. The claimed subject matter is not limited to devices, systems or methods having all of the features of any one of the devices, systems or methods described below or to features common to multiple or all of the devices, systems or methods described herein. It is possible that there may be a device, system or method described herein that is not an embodiment of any claimed subject matter. Any subject matter that is described herein that is not claimed in this document may be the subject matter of another protective instrument such as, for example, a continuing patent application, and the applicants, inventors or owners do not intend to abandon, disclaim or dedicate to the public any such subject matter by its disclosure in this document.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling can have a mechanical, optical, fluidic or electrical connotation. For example, as used herein, the terms coupled or coupling can indicate that two elements or devices can be directly connected to one another or connected to one another through one or more intermediate elements or devices via an electrical signal, an electrical connection, a mechanical element, an optical element, a fluid pathway or a light pathway depending on the particular context.

It should also be noted that, as used herein, the wording “and/or” is intended to represent an inclusive-or. That is, expressions such as “X and/or Y” are intended to generally mean X or Y or both, for example. As a further example, expressions such as “X, Y, and/or Z” are intended to generally mean X, Y, Z or any operable combination thereof such as X; Y; Z; X and Y; X and Z; Y and Z or X, Y and Z, depending on the context.

It should be noted that terms of degree such as “substantially”, “about” and “approximately” as used herein mean a reasonable amount of deviation of the modified term such that the end result is not significantly changed. These terms of degree may also be construed as including a deviation of the modified term, such as by 1%, 2%, 5% or 10%, for example, if this deviation does not negate the meaning of the term it modifies.

It should also be noted that in the context of a measurement of time, the terms “larger” and “longer” may be used interchangeably, and the terms “smaller” and “shorter” may be used interchangeably. In the context of a measurement of speed, the terms “larger” and “faster” may be used interchangeably, and the terms “smaller” and “slower” may be used interchangeably.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

The embodiments of the systems and methods described herein are implemented using a combination of hardware and software. The embodiments described herein may be implemented with computer programs executing on programmable devices, where each programmable device including at least one processor, a data storage system (including volatile memory or non-volatile memory or other data storage elements or a combination thereof), and at least one communication interface. For example, and without limitation, the programmable devices may be a server, a network appliance, an embedded device, a personal computer, a laptop, a personal data assistant, a smart-phone device, a tablet computer, or any other computing device capable of being configured to carry out the methods described herein where these devices may communicate using wired or wireless communications protocols as appropriate.

Program code may be applied to input data to perform the functions described herein and to generate output data. The output data may be displayed to a user via one or more output devices and/or electronically communicated to another devices. Each program may be implemented in a high-level procedural or object-oriented programming and/or scripting language, or both, to communicate with a computer system. The program code may be written in C++, C#, JavaScript, Python, MATLAB, or any other suitable programming language and may comprise modules or classes, as is known to those skilled in object-oriented programming. In either case, the language may be a compiled or interpreted language. However, the programs may be implemented in assembly or machine language, if desired. In any case, the language may be a compiled or an interpreted language. Such computer programs may be stored on a non-transitory computer-readable storage medium (e.g., ROM, magnetic disk, optical disc) that is readable by a general or special purpose computing device, for configuring and operating the computing device when the storage media or device is read by the computing device to perform one or more of the procedures in accordance with the teachings herein.

Furthermore, the software that implements the functionality of the methods of the embodiments described herein are capable of being distributed in one or more computer program products comprising a computer readable medium that bears computer usable instructions for one or more processors. The medium may be provided in various forms, including non-transitory forms such as, but not limited to, one or more diskettes, compact disks, tapes, chips, USB keys, and various other magnetic and electronic storage media as well as transitory forms such as, but not limited to, wireline transmissions, satellite transmissions, internet transmission or downloads, digital and analog signals, and the like. The computer useable instructions may also be in various forms, including compiled and non-compiled code.

As previously mentioned, there are various disadvantages in using conventional techniques to analyze averaged Raman spectra for scattered light obtained from sample mixtures where at least one analyte of interest is present at a low concentration. For example, when acquiring an average Raman spectrum over an extended sample region: (1) the Raman peaks or bands of the low-concentration analyte particles may be obscured or hidden by the stronger Raman peaks or bands of the other constituents of the sample mixture, or (2) other constituents of the sample mixture may fluoresce when illuminated by the laser source, causing a strong broadband emission across the spectrometer's spectral range that may further obscure the Raman signal from the low-concentration analyte particles. Both of these situations make it difficult (if not impossible) to detect and/or quantify the low-concentration analyte particles using the averaged Raman spectra.

However, in accordance with one aspect of the teachings herein, the inventors have discovered a method and apparatus for mitigating the attenuation of Raman signals from low-concentration analyte particles (i.e., the dilution effect) by acquiring Raman-shifted photons (i.e., portions of light scattered from the sample) for many short exposures as a plurality of Raman data sets with a Raman analyzer and analyzing the Raman data sets individually instead of first averaging them together. The teachings herein may be done using Raman instrumentation which permits obtaining and processing light scattered from sample mixtures over short exposures (for example, but not limited to, exposure times between about 10 and about 100 milliseconds) to generate higher-quality Raman spectral data. Examples of such Raman instrumentation are described in U.S. Pat. Nos. 8,384,896, 8,917,390, and U.S. Ser. No. 10/281,325, which are each incorporated by reference herein in their entirety. Other Raman instrumentation which may be used for implementing the teachings herein includes any spectrometer, analyzer, or spectral analysis apparatus which can collect spectra with sufficient signal-to-noise ratio to detect the desired analyte(s) of interest in short single exposures by means of, for example but not limited to, efficient collection of a large fraction (for instance about 1% to about 50%) of the Raman-scattered light beam(s), sensitive detection of the Raman-scattered photons (for instance having an optical efficiency of about 10% to about 90%), or high power of the laser illumination, including continuous-wave lasers (for instance about 100 to about 5000 mW) or pulsed lasers which concentrate a large amount of energy into a brief but intense pulse of illumination (for instance a pulse duration of about 1 ps to about 1 ms with an energy of about 1 μJ to about 10 mJ per pulse).

In conventional techniques using Raman spectroscopy, those skilled in the art held that long exposures or many averages were necessary to detect low concentrations of a given analyte, due to the inherent low intensity of the Raman scattering signal, and the exposure time and number of averages were selected based on the number of collected photons required to achieve a target signal strength or target signal-to-noise ratio.

However, when using an optical apparatus, such as the examples described in U.S. Pat. Nos. 8,384,896, 8,917,390, and U.S. Ser. No. 10/281,325 or other Raman analyzer embodiments described herein, the inventors have determined that a sufficient quantity of Raman-scattered photons from a sample may be collected in a significantly shorter exposure time, allowing for a plurality of individual measurements to be obtained in a small amount of time such as, but not limited to, 10 to 100 exposures with signal-to-noise ratio of about 50 to about 500 being collected within about 1 to about 5 seconds with an excitation laser power of about 100 to about 500 milliwatts, for example. This allows a small fraction of the Raman spectral data from the individual exposures to be acquired when the focal spot is partially or fully occupied by a particle of the one or more low-concentration analytes of interest, with minimal interference from the Raman or fluorescence spectra of the other components of the sample mixture, such that the Raman spectral signature of at least one low-concentration analyte of interest can be detected more accurately.

In one or more embodiments, the exposure times may be set based upon the typical size of the particles and their speed relative to the region of the sample illuminated by the light beam. The volume fraction of the low-concentration analyte particles can then be quantified to a specified level of precision by collecting and analyzing a sufficient number of Raman data sets from short exposures to provide statistical confidence in the quantitative results. In some embodiments, instead of utilizing short exposures by the spectrometer detector, the laser source may be pulsed such that the sample is illuminated for only a brief period of time, in which case the effective exposure time (when the detector is receiving a light signal from the sample) is substantially the same as the laser pulse duration, even if the spectrometer detector (which may also be referred to herein as a detector) is configured to receive a light signal for a longer duration. In accordance with the teachings herein, the term “exposure time” may be taken to mean the actual exposure time of the detector, or the pulse duration of a pulsed laser that is used to generate light to illuminate the sample, whichever quantity is shorter.

In accordance with another aspect of the teachings herein, it should be noted that the acquisition and analysis techniques and certain aspects of the apparatuses described herein, such as sample measurement apparatuses, may also be applied to spectroscopic modalities other than Raman spectroscopy, such as, but not limited to, broadband ultraviolet spectroscopy, visible spectroscopy, near-infrared spectroscopy, infrared spectroscopy, fluorescence spectroscopy, or laser induced breakdown spectroscopy. All of these optical spectroscopy methods also entail the illumination of a sample by a light beam and collection of photons coming from the sample, although there are differences in the details of the illumination beam, interaction of the sample with the illumination beam, and properties of the collected photons from the sample. Nonetheless, the general aspects of the teachings herein may be applied advantageously to improve the detection and measurement of low concentration analyte particles using other spectroscopic modalities in a similar fashion as detailed herein for Raman spectroscopy.

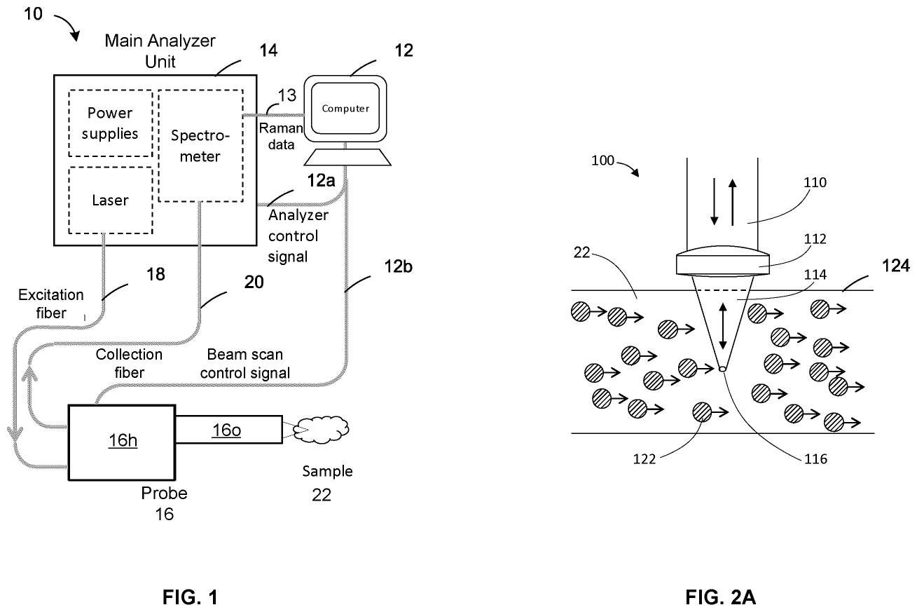

Referring now to FIG. 1, shown therein is a Raman analyzer system 10, which may also be referred to as a Raman spectrometer. While a Raman analyzer system 10 is shown, it should be understood that it is just one example of a spectroscopic system that is generally used according to the teachings herein to mitigate the attenuation of spectral signals from low-concentration analyte particles (i.e., the dilution effect) by acquiring spectra for many short exposures as a plurality of spectral data sets with a spectral analyzer and analyzing the spectral data sets individually instead of first averaging them together. This may be done using instrumentation that allows for selected exposure times that are short in duration and have a certain relationship with the transit time period for analytes of interest that move across a focal region (e.g., a focal spot, a focal line, several focal spots, etc.) and a desired speed V for the relative motion between the analytes of interest and the focal region to permit obtaining and processing light scattered from sample mixtures over short exposures (for example, but not limited to, exposure times between about 10 and about 100 milliseconds) to generate higher-quality spectral data that allow for the detection and/or quantification of low concentration analyte particles in a sample mixture. Accordingly, while the examples given in the description herein are described with respect to a Raman analyzer system and Raman spectral data, it should be understood that the teachings herein are applicable to other spectroscopic modalities and the associated apparatuses including, but not limited to, broadband ultraviolet spectroscopy, visible spectroscopy, near-infrared spectroscopy, infrared spectroscopy, fluorescence spectroscopy, or laser induced breakdown spectroscopy.

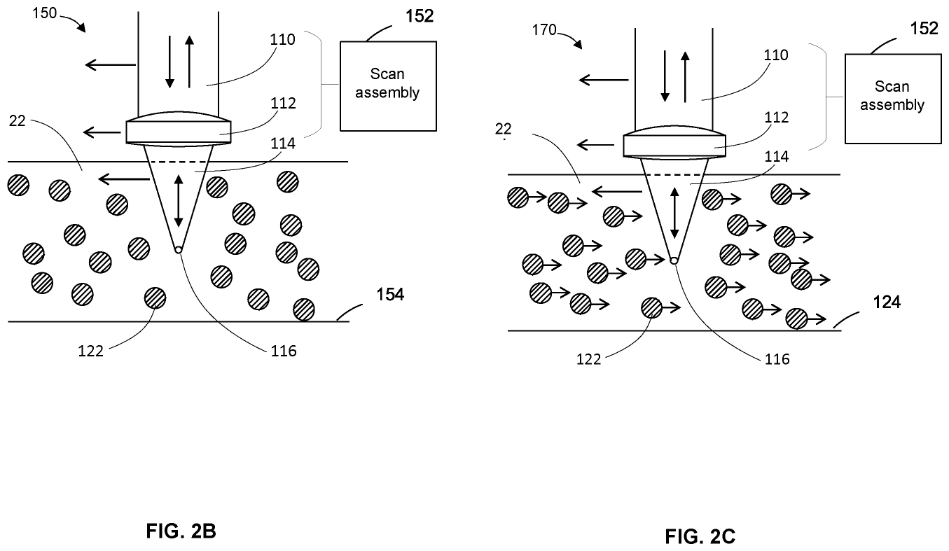

The system 10 generally comprises a computing device 12, such as a laptop or desktop computer, a main analyzer unit 14, a probe 16 that is coupled to the main analyzer unit 14 via multiple optical fiber cables including: an “excitation fiber” 18 for transmitting light energy, such as laser energy, from the main analyzer unit 14 to the probe 16 and a “collection fiber” 20 for transmitting the scattered light signal collected by the probe 16 from a sample 22 back to the main analyzer unit 14. The arrangement of the probe 16 and the sample 22 is shown for general illustrative purposes in FIG. 1 while some example embodiments of the arrangement of the probe 16 (including the probe focusing optic 122) and sample 22 are shown in FIGS. 2A-2C.

The main analyzer unit 14 generally includes a spectrometer, a light source, such as a laser, and one or more power supplies. The laser provides energy for “exciting” molecular vibrations in the sample 22 by generating light stimuli that are delivered to the sample 22. The laser may be a diode laser, a diode-pumped solid state laser, a gas laser, or any other device for generating substantially monochromatic coherent light. Although 785 nm lasers, 532 nm lasers, and 1064 nm lasers may be used in the embodiments described herein, the laser may emit light at other wavelengths. The spectrometer may be a dispersive spectrometer, a Fourier Transform spectrometer, a Spatial Heterodyne Spectrometer, or any other device for measuring the spectral energy distribution of a light source or light beam. The spectrometer generates Raman spectral data from the detection and quantification of the light intensity at different wavelengths or wavenumbers in the scattered light spectrum for light that is scattered from the sample 22 and subsequently travels to the spectrometer via the collection light beam path and collection fiber 20. The spectrometer transmits the Raman spectral data to the computer 12 via Raman data channel 13, which may be via a data cable such as a USB cable, for example. The one or more power supplies provide electricity to the electrical and/or electronic components of the laser and the spectrometer as required for their functioning. The electronic components and subsystems of the main analyzer unit 14 may be controlled by the computing device 12 via analyzer control signal transmitted through control channel 12a, which is typically transmitted using a USB cable using associated communication protocols but may be any other electrical or optical control or signaling method including (but not limited to) Ethernet, serial, fiber, WiFi, Bluetooth, or cellular. The Raman spectral data obtained by the spectrometer may be sent to the computing device 12 over Raman data channel 13 in a similar manner as the communication of the analyzer control signal to the main analyzer unit 14, or via any other electrical or optical communications method.

The probe 16 is further divided into two broad parts, the “probe head” 16h and the “sample optic” 160. The probe head 16h typically contains optical elements for collimating a diverging laser light beam that is provided from the excitation fiber 18 and directing this collimated beam to the sample optic 160, which may, for example, be a focusing lens, a flat window (e.g., for large spot mode), or other suitable optical elements. Other optical elements within the probe head 16h may include a dichroic filter for receiving and filtering at least one collimated beam of scattered light returning from the sample optic 160, an additional bandpass optical filter to remove non-Raman-scattered light, and a collection focuser which then focuses the filtered scattered return light down into the collection fiber 20. In alternative embodiments, the receiving of the at least one collimated beam of scattered light returning from the sample 22 may be performed by one or more separate probe optics and probe heads (not shown) as is known by those skilled in the art.

For the sample optic 160 (also sometimes referred to as the objective optic, non-contact optic or immersion optic), current state-of-the-art typically entails a single plano-convex or biconvex lens. In these types of Raman probe sample optics, the lenses have one or more surfaces which are parts of a sphere, or a lens which is a complete sphere. Such optical elements are called “spherical optics” by those skilled in the art, even when the optical elements do not comprise a complete sphere.

Using a beam scan control signal that is communicated via data channel 12b, the computing device 12 may also control a scanning mechanism that is part of the probe 16, to change the angle or position of the illumination beam relative to the sample 22. Various embodiments of this scanning mechanism are described herein. The beam scan control signal may be a digital control signal that is communicated using a certain protocol, such as but not limited to USB, serial, or Ethernet, for example. Alternatively, the beam scan control signal may be one or more analog control signals such as but not limited to one or more current signals, voltage signals, or electrical frequency signals.

In addition, although FIG. 1 shows that the analyzer control signal, which may be sent via control channel 12a, and the beam scan control signal are communicated using a physical cable or wire, in at least one alternative embodiment the analyzer control signal and/or the beam scan control signal may be transmitted using digital or analog wireless communications and control protocols such as (but not limited to) WiFi, Bluetooth, RFID, XBee, Zigbee, Z-Wave, or cellular. In any of these wired or wireless embodiments, the computing device 12 is electrically coupled to the main analyzer unit 14 and/or the probe 16. Similarly, the Raman data channel 13 may be implemented with a physical wire or cable, or alternatively using digital or analog wireless communications such as those listed above.

By way of example, FIG. 2A shows an example embodiment of a sample measurement apparatus 100, that may be used by the Raman analyzer of FIG. 1, where a moving inhomogeneous sample 22, with analyte particles 122, is in a flow channel 124 and is being illuminated by a light beam 114. The flow channel 124 may be a pipe, a tube, a conduit, a trench, a hopper, a conveyor belt, or any other mechanism which contains and guides the sample 22 in motion. In alternative embodiments, the flow channel 124 may be a portion of the interior of a container, vessel, reactor, chamber, or other physical volume which contains the sample 22, wherein the sample 22 is stirred or otherwise impelled to move within these types of containers. An initially collimated light beam 110 is focused by lens 112 (part of the sample optic 160 of FIG. 1), into a converging beam 114 which forms a focal spot 116 upon a surface of the sample or within a volume of the sample 22. The focal spot 116 may have a diameter represented by the variable S (not shown in FIGS. 2A-2C). The movement of the sample 22 may be defined as moving at a relative speed V relative to the stationary focal spot 116.

The collimated beam 110 may comprise a substantially monochromatic laser beam for Raman spectroscopy, a broadband ultraviolet, visible, near-infrared, or infrared light beam for reflectance or absorbance spectroscopy, a high-intensity laser beam for laser induced breakdown spectroscopy, or other type of light beam for other spectroscopic modalities.

The lens 112 may comprise a singlet or multi-element lens system, one or more curved mirrors, or any other optical system which creates a focal spot 116 or an afocal spot 116 from the collimated beam 110. Lens 112 may also be a cylindrical lens or other optical system which forms a “focal line” of illumination light, or a plurality of lens elements (such as a lenslet array) which forms multiple focal spots upon a surface of the sample 22 or within a volume of the sample 22. In other embodiments, multiple focal spots can be generated from multiple collimated beams and lenses. Lens 112 or an equivalent optical system may also be located to collect light which is scattered, reflected, or emitted from the sample 22 in response to the illumination beam 110 and 114, collimate this collected light, and send it back to the spectrometer, as represented by the bidirectional arrows in beams 110 and 114. The focal line or plurality of focal spots may all be optically coupled to the spectrometer in a manner which provides a single spectrum representative of the entire focal line region or plurality of focal spot regions, or may couple to a plurality of independent channels within the spectrometer (and/or a plurality of separate spectrometers) which collectively provide a plurality of independent spectra with each exposure of the spectrometer detector(s) or sensor(s). The properties of the lens 112 or equivalent optical system (including but not limited to position, angle, focal length, diameter, material, and/or optical coatings) may be chosen to place the focal spot 116, or in other embodiments a focal line or a plurality of focal spots, at a desired location upon a surface of the sample 22 or within a volume of the sample 22 which may provide the desired measurements given the size, geometry, and other properties of the sample 22 and the flow channel 124.

In other alternative embodiments, the lens 112 may be used to focus the illumination light 110 upon a surface of the sample 22 or within a volume of the sample 22, and a separate lens, mirror, multi-element lens, or optical system may be used instead of lens 112 or equivalent optical system to collect the light returning from the sample. The properties of the plurality of lenses or optical systems (including but not limited to position, angle, focal length, diameter, material, and/or optical coatings) may be chosen to place the focal spot 116, or focal line or plurality of focal spots in other embodiments, at the desired location upon a surface of the sample 22 or within a volume of the sample 22, given the size, geometry, and other properties of the sample 22 and the flow channel 124 as explained previously.

In yet other alternative embodiments, the collimated beam 110 may be permitted to directly illuminate the sample 22 in an afocal fashion without any focusing, and the scattered return beam from the sample 22 may be collected with or without focusing. Although illumination with a collimated beam will reduce the Raman signal as mentioned above, this embodiment may be desirable when there is a variable distance between lens 112 and the sample surface (e.g., the portion of the sample 22 closest to the lens 112), such as a Raman system which measures large chunks of rock tumbling down a chute. In another example, a collimated beam may be desirable if the typical diameter of the analyte particles 122 is substantially similar to the diameter of the collimated illumination beam 110.

In the various embodiments described herein, the terms “focal spot”, “focal region”, or “illumination spot” are used to encompass all of the embodiments of spectroscopic illumination and collection described herein, regardless of whether the beams are fully focused into a single spot or multiple spots, partially focused into a line, or unfocused.

Distributed within the inhomogeneous sample 22 are discrete units of at least one analyte of interest 122, where these units may be referred to as different analyte types such as, but not limited to, particles, grains, clumps, clusters, bubbles, strands, or other structures, for example. Any of these analyte units may also be referred to as analyte “particles”. Although the analyte particles generally will not all have the same size and shape, they may have a characteristic size P which may have various values but typically is a size in the range of about 100 nanometers to about 1 centimeter. Use of the term “size” herein refers to a linear length measurement from one side of the object or entity, substantially through its center, to the other side. The “size” of a sphere or circle is equivalent to its diameter. For objects of an irregular shape such as some particles, the “size” may be taken to mean the average linear dimension measured through the center of the object. The region or volume of the sample 22 which is not occupied by analyte particles 122 may be referred to as the background matrix. For a group of objects, the term “characteristic size” may be used to refer to an average or typical size of the individual objects in the group.

All analyte particles in a sample mixture 22 may have substantially the same chemical composition, or there may be a plurality of different analyte types with different chemical compositions present in the sample mixture 22. Depending on the details of the process that provides the sample 22, all analyte particles of the plurality of analyte types may be the same or different type and all have substantially the same characteristic size P, or different analyte particles (whether of the same type or different types) may have different characteristic sizes P₁, P₂, P₃, etc. The teachings herein apply equally to embodiments with a single analyte type or a plurality of analyte types with the same characteristic size P or a plurality of characteristic sizes P₁, P₂, P₃, etc.

In the example embodiment shown in FIG. 2A, there is a sample measurement apparatus 100, that may be used by the Raman spectrometer of FIG. 1, in which the sample 22 is moving from left to right at a speed V in the flow channel 124. The sample measurement apparatus 100 refers to a portion of the sample optic 160 and its physical relation to the sample 22. In general, the sample 22 may be moving in any direction, and an example direction has been chosen for illustrative purposes in FIG. 2A. By way of example, this movement may be the flow of a liquid, powder, or slurry within a flow channel 124 as shown in FIG. 2A, but in other embodiments this movement may be due to the conveyance of a powder or particle mixture on a belt or translating/rotating platform; or material falling downwards under the influence of gravity, or material moving within a container, which may also be considered to be types of flow channels.

In other alternative example embodiments, such as that depicted in FIG. 2B, there is a sample measurement apparatus 150, that may be used by the Raman spectrometer of FIG. 1, in which all of the same elements are present as the sample measurement apparatus 100, but the sample 22 and the analyte particles 122 therein are in a vessel such as a container 154 and are stationary while the beams 110 and 114, the lens 112, and the focal spot 116 move in a certain direction, such as a lateral direction (e.g., from right to left as shown in FIG. 2B but the direction may be from left to right in other embodiments), at a speed V due to the operation of a scan assembly 152 which may be implemented in various ways such as, but not limited to, a translation mechanism, a rotation mechanism, or a scanning mechanism. The scan assembly 152 may be controlled via the beam scan control signal so that the focal spot 116 may be scanned such that it moves relative to the sample 22 at a selected relative speed V.

For example, in embodiments that use a translation mechanism as part of the sample measurement apparatus 150, the translation mechanism may comprise a translation stage driven by a stepper motor, linear motor, or solenoid, with the lens 112 mounted upon the translation stage such that moving the translation stage causes the focal spot 116 to move relative to the sample 22 at the selected relative speed. Alternatively, in at least one example embodiment, the beam 110 may remain stationary while the lens moves (e.g., turns or rotates) to move the position of the focal spot to the desired location. In such embodiments, a lens may be used that is wide enough so that the beam 110 physically interacts with the lens 112 throughout the scan so that the focal spot is formed on the optical axis of the lens 112, regardless of where the beam 110 contacts the lens 112.

Alternatively, in embodiments that use a rotation mechanism as part of the sample measurement apparatus 150, the rotation mechanism may be implemented in various ways such as, but not limited to, for example, a pivoting or rotating mirror between the lens 112 and the sample 22 which deflects the converging beam 114 and changes the location of the focal spot 116 within a volume of the sample 22 or upon a surface of the sample 22 along a rotational or translational path at the selected speed, while the beam 110 and lens 112 remain stationary.

Alternatively, in embodiments that use a scanning mechanism as part of the sample measurement apparatus 150, the scanning mechanism may be implemented using, for example, but not limited to, a pivoting or rotating mirror, an acousto-optic modulator, a zoom lens, or a liquid lens which may be activated to change the position of the focal spot 116 within a volume of the sample 22 or upon a surface of the sample 22 at the selected speed V. In the cases of the zoom or liquid lenses, scanning to different depths may be done by adjusting the focusing optics rather than physically moving the entire optical assembly by a large distance. With a zoom lens, small movements of one or more optical elements inside the zoom lens assembly may cause the focal spot 116 to move a larger distance along the primary optical axis, thereby providing Raman measurements at a surface of the sample 22 or at different depths within a volume of the sample 22. With a liquid lens, a mechanism inside the lens assembly causes a change in the curvature of one or more surfaces of a liquid optical element or otherwise deformable transparent or reflective optical element, altering the lens assembly's effective focal length such that the focal spot 116 moves along the primary optical axis, thereby providing Raman measurements at a different depth within a volume of the sample 22. In another embodiment, a standard fixed lens such as lens 112 may be moved substantially along the optical axis of collimated beam 110 by a mechanical device such as (but not limited to) a solenoid, a linear servo, or a linear motor, such that the focal spot 116 is placed deeper or shallower within sample 22 at selected relative speed V.

In these aforementioned example embodiments, the entire optical system may be translating relative to the sample 22 or the optical system may be stationary but have elements that may be moved or otherwise operated to allow the beam 114 to be spatially scanned in one or more axes. Also, throughout this specification, the terms “scan”, “scanned”, or “scanning” may refer collectively to the aforementioned translation motions, rotation motions, scanning motions, or any combination thereof which results in a corresponding scanning pattern that is followed by the focal spot 116.

Referring now to FIG. 2C, shown therein is another example embodiment of a sample measurement apparatus 170 that can be used with the system of FIG. 1 where an inhomogeneous sample 22 is being illuminated by a light beam 114 and both the sample 22 and the focal spot 116 may be in motion, which may be implemented as a combination of the sample measurement apparatus 100 shown in FIG. 2A and the sample measurement apparatus 150 shown in FIG. 2B. Accordingly, the sample 22 is moving within a flow channel or container 124, as was previously described, and the sample measurement apparatus 170 includes the scan assembly 152 for moving the light beam 114 and ultimately the focal spot 116. The scan assembly 152 may be controlled via the beam scan control signal so that the focal spot 116 may be scanned such that it moves in substantially in the same direction as the movement of the sample 22, or in substantially the opposite direction as the movement of the sample 22, in order to achieve a smaller or larger relative speed V (respectively), e.g., speed difference, between the movement of the sample 22 and the focal spot 116. It should be noted that embodiments in which the focal spot moves, such as those shown in FIG. 2B and FIG. 2C, may configure the scan assembly to periodically scan rapidly or “jump” the scan position discontinuously back to the scan starting point, thereby possibly skipping or missing a portion of the sample 22 if the beam 114 is moving in the same direction as the sample 22 (other than when returning to the starting point), or measuring a portion of the sample 22 more than once if the beam 114 is moving in the opposite direction as the sample 22 (other than when returning to the starting point).

Alternatively, in another example embodiment, the scan assembly 152 may be controlled via the beam scan control signal so that the focal spot 116 may be scanned such that the focal spot 116 moves perpendicular to the direction of the movement of the sample 22, or at an angle relative to the direction of movement of the sample 22, to collect spectroscopic data from different locations or different depths within the flow of the sample 22, for instance closer to the sides of the flow channel 154 within which the sample 22 flows where the density or composition of the analyte particles 122 may be different. Scanning perpendicular or at an angle relative to the direction of flow of the sample 22 may be desirable in situations when the flow speed is slow relative to the scan speed, such that the focal spot 116 may “sweep” rapidly back and forth according to a desired/selected scanning pattern as the sample 22 moves more slowly past the scan mechanism 152. In this fashion, a larger region or volume of the sample 22 may be covered by the measurement method.

In all such cases where the sample 22 and the focal spot 116 are moving relative to each other, the relative speed V may range most commonly between about 10 microns per second and about 100 meters per second (but may include speeds smaller than about 10 microns per second or larger than about 100 meters per second). The relative speed V may depend upon the speed of the sample flow and also upon the maximum scan speed of the scan assembly 152, but within those implementation specifications a relative speed V may be chosen based on a desired exposure time as detailed below.

In either embodiment shown in FIGS. 2A and 2B, the focal spot 116 will periodically encounter one of the analyte particles 122. Due to the relative motion between the focal spot 116 and the flow of the sample 22, at least one of the analyte particles 122 will be illuminated by the light beam 114 fora transit time T which is the amount of time that it takes for the analyte particles 122 to travel across the focal region (e.g., the focal spot 116) provided by the light beam 114. In the case that the size S of the focal spot 116 is substantially smaller than the size P of the analyte particles 122, the transit time T will be substantially equal to the particle size P divided by the relative sample speed V. In the case that the focal spot size S is substantially larger than the particle size P, the transit time T will be substantially equal to the focal spot size S divided by the relative sample speed V. If P and S are approximately equal, then the transit time T will be substantially equal to the sum of the particle size P and the spot size S, which is then divided by the relative sample speed V. In turbulent flows, the sample speed V may not be constant, but in this case the calculations described above may still be utilized by substituting an average speed V over the transit time T in question. In cases where there is a plurality of characteristic particle sizes P₁, P₂, P₃, etc. in the sample, these calculations may be performed using a value of P which is the average of the different particle sizes, or the maximum particle size, or the minimum particle size, or one specific particle size, or some other value which represents a compromise among the different particle sizes present. In some embodiments with substantially different sample particle sizes P₁, P₂, P₃, etc., the calculations may be performed based upon one specific particle size, such that the detection method is optimized or “tuned” to detect particles of that specific size. In some cases when the center of the analyte particle does not pass directly through the center of the focal spot, then the transit time T may be shorter than the calculations described above, due to the particle intersecting a shorter chord of the focal spot, or the focal spot intersecting a shorter chord of the analyte particle. However, the majority of the interactions between an analyte particle and the focal spot will produce a transit time T of approximately the same duration as calculated by the aforementioned equations.

Sample measurement apparatuses 100, 150 and 170 are part of a larger spectroscopic analysis system which typically includes a spectrometer, such as that shown in FIG. 1, which receives the light returned from the sample 22 via the lens 112 and the collimated light beam 110, separates the photons by wavelength using a dispersing element or other spectroscopic elements, and detects the photons with a camera, detector, or sensor, which may be a CCD, a CMOS array, a photodiode or photodiode array, or other light-sensitive element in the spectrometer. Such detection elements are typically configured to receive, detect and measure photons during a specific period of time E, called the exposure time or integration time, after which the light intensity values are reported to a recording device such as the computer 12.

As discussed previously, conventional spectroscopic measurement of an inhomogeneous sample mixture often entails setting the exposure time E to a value such that a substantial quantity of the sample 22 passes by the focal spot 116, and the resulting spectrum represents the average chemical composition of a region or volume of the sample 22 that has a width substantially equal to the diameter of the focal spot 116 and a length substantially equal to the exposure time E times the relative movement V. The exposure time E is typically chosen such that a sufficient number of scattered photons are collected from the sample 22 to provide adequate signal-to-noise ratio in the spectral data for the desired measurements such as, but not limited to, for example, collecting 10,000 photons to reach a signal-to-noise ratio of 100 for measurements with 1% precision. Alternatively, the exposure time E may be chosen to collect sufficient photons to utilize the dynamic range of the detection element in the spectrometer such as, but not limited to, for example, achieving a peak intensity of about 200,000 photons when the detection element is a camera with a full well depth of about 300,000 photons. Due to the relative motion V of the sample 22 and the focal spot 116, collecting spectral signal over a period of time has the effect of spatially averaging over that region or volume of the sample 22 illuminated by the focal spot 116. A similar averaging effect may be achieved if multiple separate exposures are acquired with the spectrometer detector and the resulting spectra are averaged or summed together before analysis, in which case the exposure time E represents the cumulative exposure time of all of the separate exposures added together.

This averaging method is advantageous in that the final averaged spectrum provides a more representative assessment of the overall chemical composition of the sample mixture 22. However, averaging with long exposure times or multiple exposures may make it more difficult to detect trace analyte particles in the sample mixture 22. By way of example, consider a scenario where the exposure time E is set to be 100 times larger than the transit time T that is required for an analyte particle 122 to pass fully through the focal spot 116. If a single analyte particle 122 passes through the focal spot 116 during a given exposure, then the spectrum measured by the spectrometer detector will be 99% from the spectral properties of the background matrix of the sample 22 and only 1% from the spectral properties of the analyte particles of interest. As such, the spectral peaks, bands, or other features representative of the analyte particles of interest may be small compared to the spectral peaks, bands, of other Raman spectral features due to the background matrix. The Raman spectrum of the background matrix may therefore interfere with or obscure the Raman spectrum of the analyte particles of interest, making it more difficult (if not impossible) to make a reliable analysis of the presence or proportion of at least one of the analyte particles of interest in the sample 22.

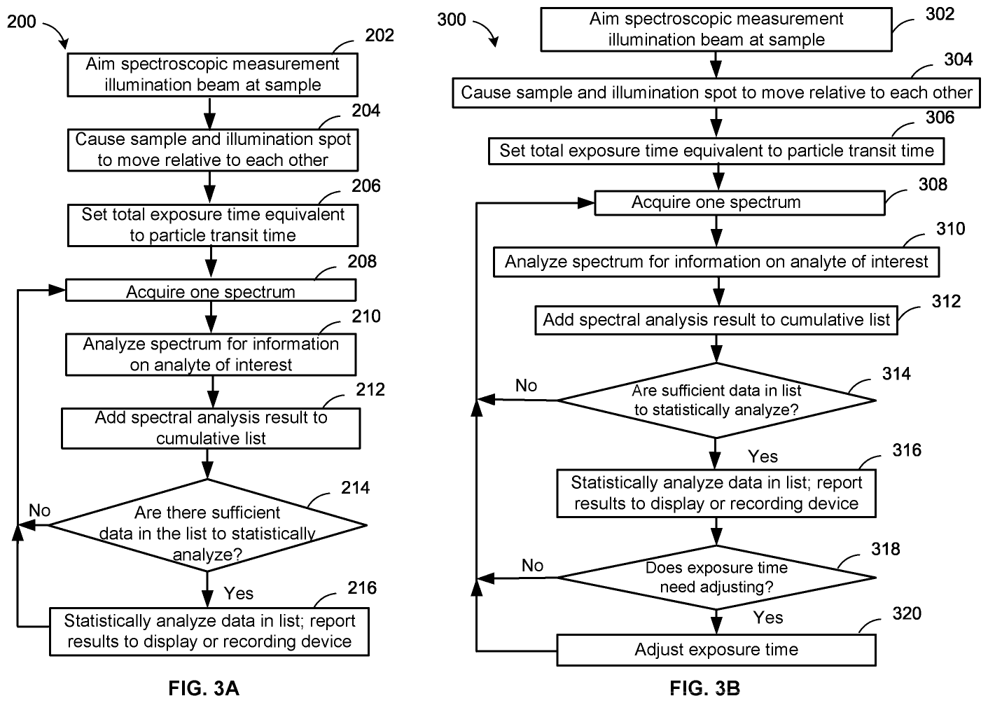

Referring now to FIG. 3A, shown therein is an example embodiment of a method 200 for performing spectroscopic measurements of different types of sample mixtures including inhomogeneous sample mixtures. The method 200 encompasses steps or acts 202 to 216. The method 200 may be performed using the Raman system 10 of FIG. 1. Also, while the method 200 is described for Raman spectroscopy, it may generally be used with other spectroscopic instruments that employ other spectroscopic methods such as, but not limited to, broadband ultraviolet spectroscopy, visible spectroscopy, near-infrared spectroscopy, infrared spectroscopy, fluorescence spectroscopy, or laser induced breakdown spectroscopy.

In act 202, the method 200 includes configuring a spectroscopic measurement system having a sample measurement apparatus, analogous to what is shown in FIGS. 2A, 2B and 2C, by aligning the components of the sample measurement apparatus so that when the illumination beam 114 is generated it is aimed at a region or volume of the sample 22 so that it forms a focal region upon a surface of the sample 22 or within a volume of the sample 22.

In act 204, the method 200 includes causing the sample 22 to move relative to the focal spot 116, either by: (a) causing the sample 22 to move past a stationary illumination beam apparatus such as the sample measurement apparatus 100; (b) causing the illumination beam apparatus such as the sample measurement apparatus 150 and the resulting focal spot 116 to move upon or within a stationary sample 22; or (c) causing both the illumination beam 110 and focal spot 116 as well as the sample 22 to move relative to one another using the sample measurement apparatus 170. In any of these cases, there is relative motion between the sample and the focal region at a relative speed V.

In act 206, the method 200 includes selecting the exposure time E (or total integration time E if multiple exposures are averaged or summed together) for the spectrometer detector based on the transit time T required for an analyte particle of characteristic size P to traverse the focal region (i.e., illumination/focal spot 116). For example, the exposure time E may be selected to be approximately equal to the transit time T. This act is fundamentally different compared to conventional methods, described earlier, where the exposure time E is chosen to reach a desired signal-to-noise ratio or percentage of dynamic range. If the focal spot 116 is larger than the analyte particles 122 then the transit time T may be determined by dividing the size S of the focal spot 116 by the speed V at which the sample 22 is moving relative to the focal spot 116. If the particles 122 are larger than the focal spot 116, then the time T may be determined by dividing the size P of the analyte particles 122 by the flow speed V of the sample 22. If the focal spot 116 and the analyte particles 122 are approximately the same size, then the time T will be substantially equal to the sum of the particle size P and the focal spot size S, which is then divided by the flow speed V. Techniques for determining the size of the analyte particles 122 will be described later in this description.

In act 208, the method 200 includes acquiring a Raman data set comprising a single Raman spectrum.

In act 210, the method 200 includes analyzing the single Raman spectrum to detect the presence, absence, or intensity of a spectral signal or spectral pattern representative of at least one analyte particle of interest. Examples of analysis that can be performed at act 210 are provided later in the description.

In act 212, the method 200 includes adding the result of that spectral analysis to a list of results from analysis of other prior Raman spectra, and this list of results may be statistically analyzed. The results are the output of analyses that are performed on the Raman spectra such as, but not limited to, a concentration value, and a true/false result, for example.

In act 214, the method 200 includes deciding whether to perform a certain type of statistical analysis. If so, then the statistical analysis is performed and the results of the statistical analysis are provided to a display of a computing device, transmitted to another device such as a recording device and/or stored to a database or other data store in act 216. Details of how this decision is made are provided below.

The method 200 then returns to act 208 to repeat acts 208 to 216 to obtain additional Raman spectra, perform the analysis of each Raman spectrum, and possibly perform the statistical analysis. Therefore, the method 200 involves acquiring a plurality of sets of spectral data corresponding to a plurality of spectra for a region of the inhomogeneous sample 22 within the focal region using the selected exposure time E, as well as analyzing each spectral data set to generate one or more corresponding analytical results for each spectrum thereby generating a set of analytical results.

The sequence from act 208 to act 216 may continue as long as measurements are needed from the sample 22. If the sample 22 is part of a continuous manufacturing process, for instance, then the sequence may continue for as long as the manufacturing is being performed or testing of the manufacturing results is being performed. Alternatively, if there is no more sample 22 to process or the results of the chemical monitoring are no longer needed for the process in question, then the method 200 may be halted at any act between act 208 and act 216.

By following method 200, the spectroscopic system's sensitivity to the analyte of interest may be enhanced compared to traditional sampling and analysis methods which use longer exposures or many averages. For example, if the analyte of interest has a low concentration in the sample mixture 22, then most of the exposures with time duration E will generate Raman spectra where the sample mixture's background matrix (including other analytes, if present) will dominate. However, when at least one analyte particle of interest passes through the illumination spot 116 during one exposure, the resulting Raman spectrum will be largely representative of the chemical composition of the at least one analyte particle of interest. This Raman spectrum may show some spectral features of the background matrix, but the spectral signal of the background matrix will be significantly lower than in the case of a long exposure time (E>>T) or multiple averaged exposures such as, but not limited to, about 10 to 100 times lower, for example. As such, using the teachings herein, the background matrix spectrum will interfere with the analyte spectrum to a much lesser degree such that any overlapping spectral bands will be reduced in amplitude and spectral extent, and any broadband background such as fluorescence will be reduced. Spectral analysis algorithms (as detailed below) may then detect and quantify the analyte particles of interest with better precision and be able to achieve a lower limit of detection for the presence or absence of the analyte particles of interest for these particular Raman spectra.

The enhanced detection/quantification provided by the method 200 involves setting the exposure time E based on the characteristic particle size P of the analyte particle of interest and the relative speed V between any movement of the focal spot 116 and any motion of the sample 22. However, P and V may not be precisely known, or either or both parameters may vary among particles of the same analyte type or P and V may vary among different analyte types. Nevertheless, if the exposure time E is selected to be slightly shorter or longer than the average or estimated transit time T, then the method 200 will still function effectively. However, if E is selected to be significantly shorter than T, for example if E is less than about one tenth of T, then the total number of photons scattered from the analyte particles of interest 122 and detected by the spectrometer during the exposure time will be reduced, and the signal-to-noise ratio (SNR) of the spectral signature of the analyte of interest may be lower due to shot noise and the intrinsic noise of the spectrometer detector. Conversely, if E is much longer than the average or estimated T, for instance if E is more than about ten times T, then the spectral signature of the analyte of interest may become diluted or overwhelmed by the spectral signature of the background matrix. As a general guideline, therefore, the exposure time E for the detector may be selected to be between about one tenth the transit time T and about ten times the transit time T for the method 200 to be effective. In at least one embodiment, the exposure time E for the detector may be substantially equal to the transit time T. The transit time T may be estimated but the exposure time E is selected as desired based on the above guideline and the estimated transit time T.

An alternative embodiment of apparatus 10 may include one or more devices for directly measuring the relative speed V (or directly measuring the particle motion to calculate the relative speed V based on the known and/or controlled scan speed), the particle size P, or both. In some embodiments, the particle motion speed may already be known, such as a solid sample being transported on a conveyor belt which is moving at a rate determined by the conveyor belt motor controller, or alternatively a liquid sample which is moving at a rate determined by a pumping mechanism, for example.

For directly measuring the relative speed V, embodiments may include a motion sensor such as, but not limited to, a flow meter, a video camera, a venturi meter, an anemometer, or a Doppler-based velocimeter, for example, that obtain motion measurement data and provide this data to a computing device, such as the computer 12 or another control apparatus, which may be configured via software to use the motion measurement data to determine the relative speed V and then use the determined relative speed V to update the beam scan control signal and/or analyzer control signal to adjust the scan speed and/or exposure time E, respectively, to maintain acceptable performance of the method 200.

For example, if the determined relative speed V is slower than the expected or estimated relative speed (for example but not limited to more than about 50% slower) as would be the case if the sample motion in the opposite direction to the scan motion is slower, then the transit time T increases (i.e., gets larger) such that it is no longer matched to the exposure time E. To address this, the exposure time E may be increased to match the larger transit time T (and increase the amount of light beam reflections captured from the analyte particles of interest), the scan speed may be increased (in the opposite direction to the particle motion) to reduce the transit time T (and increase the number of measurements that can be made in a given time) or the speed of the sample motion might be adjusted, in cases where this is possible (such as the conveyor belt or liquid pump example embodiments mentioned above), to attempt a good match between the exposure time E and the transit time T. Alternatively, in at least one embodiment, the size S of the focal region may be reduced (for example, by selecting a different focusing lens 112 or adjusting the configuration of an adjustable focusing lens 112), thereby decreasing the transit time T to better match the exposure time E.

Conversely, if the determined relative speed V is faster than the expected or estimated speed (for example but not limited to more than about 50% faster), then the transit time T decreases correspondingly (i.e., gets smaller) and the light beam reflections from the analyte particles of interest may be insufficient for the desired signal and/or be overwhelmed by the light beam reflections from the background matrix instead of the analyte particles of interest during a single exposure. To address this, the exposure time E may be decreased to match the smaller transit time T (and reduce the reflections from the background matrix) or the relative speed V may be decreased (for example but not limited to changing the scan speed or changing the flow speed of the sample when possible) to increase the transit time T and thus increase the reflections from the analyte particles of interest. Alternatively, in at least one embodiment, the size S of the focal region may be enlarged (for example, by selecting a different focusing lens 112 or adjusting the configuration of an adjustable focusing lens 112), thereby increasing the transit time T to better match the exposure time E.

Furthermore, for directly measuring the particle size P (or a plurality of different particle sizes), an alternative embodiment of the system 10 may include one or more measurement sensors such as, but not limited to, an imaging system for obtaining separate image data (e.g., snapshots), a video camera for obtaining continuous video data, or a laser diffraction apparatus, for example, that obtain size measurement data and provide this data to a computing device, such as the computer 12 or another control apparatus, which may be configured via software to use the size measurement data to determine the analyte particle size which may then be used to update the beam scan control signal and/or analyzer control signal to adjust the scan speed and/or exposure time E to maintain acceptable performance of the method 200.

For example, if the determined particle size P is larger than expected (for example but not limited to more than about 50% larger) then the transit time T increases and will not be matched with the exposure time E. To address this, the exposure time E may be increased (i.e., made larger) to match the higher (i.e., larger) transit time T (and capture more light beam reflections from the analyte particles of interest) or the relative speed V may be increased (for example but not limited to changing the scan speed or changing the speed of the sample flow when possible). Alternatively, in at least one embodiment, the size S of the focal region may be enlarged (for example, by selecting a different focusing lens 112 or adjusting the configuration of an adjustable focusing lens 112), thereby increasing the transit time T to better match the exposure time E.

Conversely, if the determined particle size P is smaller than expected (for example but not limited to more than 50% smaller) then the transit time T decreases (i.e., is smaller) and the light beam reflections from the analyte particles of interest may be insufficient for the desired signal and/or be overwhelmed by the light beam reflections from the background matrix instead of the analyte particles of interest during a single exposure. To address this, the exposure time E may be decreased to match the smaller transit time T (and reduce the reflections from the background matrix) or the relative speed V may be decreased (for example, but not limited to changing the scan speed or changing the speed of the sample flow when possible) to increase the reflections from the analyte particles of interest. Alternatively, in at least one embodiment, the size S of the focal region may be decreased (for example, by selecting a different focusing lens 112 or adjusting the configuration of an adjustable focusing lens 112), thereby decreasing the transit time T to better match the exposure time E.

Alternatively, in other embodiments, one or more sensors may be used that can collectively obtain motion and particle size measurement data and provide the data to a computing device, such as computer 12, which is configured via software to measure/determine both the relative speed V and the analyte particle size P, and then adjust the exposure time E and/or scan speed based on the determined speed and particle size.

For example, the determined particle size P and the determined relative speed V may both indicate that the transit time T is larger than the exposure time E. To address this, the exposure time E may be increased (i.e., made larger) to match the higher (i.e., larger) transit time T (and increase the reflections from the analyte particle of interest), or the scan speed or sample flow speed may be changed to increase the relative speed V (so that the number of measurements taken in a given time period is not reduced), or the focal region size S may be decreased to reduce the transit time T.

Conversely, the determined particle size P and the determined relative speed V may both indicate that the transit time T is smaller than the exposure time E. To address this, the exposure time E may be decreased to match the smaller transit time T (and reduce reflections from the background matrix), or the scan speed or sample flow speed may be changed to decrease the relative speed V, which will increase the transit time T (and increase the reflections from the analyte particles of interest), or the focal region size S may be enlarged to increase the transit time T.

Accordingly, for the embodiments described above, as previously taught, the (a) exposure time E, (b) scan speed (in embodiments which include a means of scanning the illumination beam), (c) sample speed (in embodiments which include a means of controlling the sample flow or motion), (d) focal region size S, or (e) any operable combination of (a) to (d) may be chosen or adjusted such that the exposure time E is substantially similar to the transit time T required for an analyte particle to transit the focal region of size S, or for the focal spot to transit the analyte particle of size P, at a relative speed V.

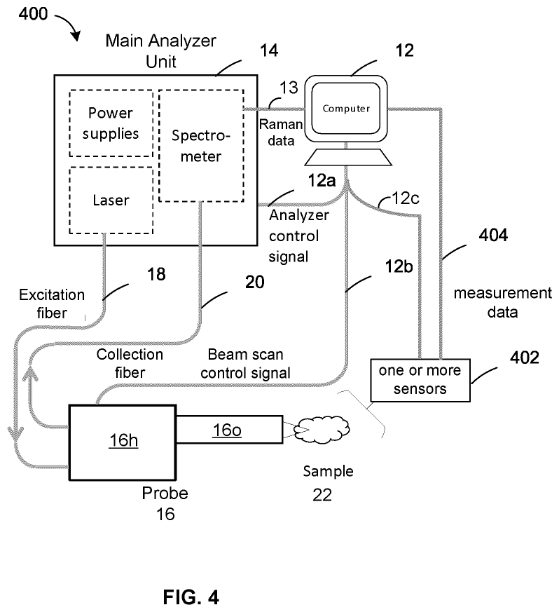

Referring now to FIG. 4, shown therein is a Raman analyzer system 400 which is similar to the Raman analyzer system 10 except for the addition of one or more sensors 402 that receive a sensor control signal via control channel 12c from the computing device 12 to obtain measurement data regarding the sample 22 and send the measurement data over measurement data channel 404 to the computing device 12. The one or more sensors 402 may include a motion sensor, examples of which were described earlier, for obtaining motion measurement data from which the relative speed V may be determined as described previously. Alternatively, the one or more sensors 402 may include a size measurement sensor, examples of which were described earlier, for obtaining size measurement data from which the analyte particle size may be determined as described previously. Alternatively, the one or more sensors 402 may include a motion sensor for obtaining motion measurement data and a size measurement sensor for obtaining size measurement data from which the analyte particle size may be determined. The measurement data obtained by the one or more sensors 402 may be sent to the computing device 12 via measurement data channel 404 in a similar manner as the communication of the spectroscopic Raman data from the main analyzer unit 14 to the computing device 12 via Raman data channel 13 (e.g., wired or wirelessly using an appropriate communication protocol). The one or more sensors 402 may be physically integrated at the surface of the flow channel 124/154 in a similar fashion and location as the Raman measurement lens 112, or the one or more sensors 402 may be located in a different part of the flow channel 124/154 or different part of the system 10.

In another example embodiment, a method 300 for performing spectroscopic measurements of different types of sample mixtures including inhomogeneous sample mixture is shown in FIG. 3B. The method 300 may be performed using the Raman system 400 of FIG. 4. Also, while the method 300 is described for Raman spectroscopy, it may generally be used with other spectroscopic systems that employ other spectroscopic methods such as, but not limited to, broadband ultraviolet spectroscopy, visible spectroscopy, near-infrared spectroscopy, infrared spectroscopy, fluorescence spectroscopy, or laser induced breakdown spectroscopy.

The method 300 is similar to method 200 but adds acts 318 and 320 wherein the exposure time E is adjusted. The exposure time E may be adjusted in response to the statistical analysis of the list of results from acts 312 and 316. Alternatively, the exposure time E may be adjusted based on the measured relative speed V and/or the analyte particle size P, as described with respect to FIG. 4. If the exposure time E is set “correctly”, i.e., substantially equal to the actual transit time T of the analyte particles 122 through the focal spot 116, then some of the analyte particles 122 that are randomly distributed in the sample 22 will enter the focal spot 116 partway through an exposure, and then may still be within the focal spot 116 during part of the subsequent exposure, assuming that the subsequent exposure starts very soon after the prior exposure, for example, with a delay time between consecutive exposures that is less than one tenth of the exposure time E. As such, the list of results from spectral analysis will sometimes show two consecutive detections of the analyte of interest when in fact there is just the same single analyte particle 122 passing through the focal spot 116 that is detected twice. These “double detections” can be considered a normal aspect of the random distribution of the analyte particles 122 in the sample 22 and may in fact constitute the majority of detections of the analyte particles of interest. Furthermore, the relative strength of the Raman signal from the analyte particles of interest between the first spectrum and second spectrum of a double detection may provide useful additional information to be statistically analyzed. However, if the statistical analysis of the results list that is performed by a computing device (or other equivalent apparatus) discovers a significant number of instances (for example, more than one out of 100 instances) where the spectral signature of the analyte particles of interest appears in three consecutive spectra, this may indicate that the exposure time E is actually shorter than the transit time T, as the spectrometer system is able to make multiple exposures of the same analyte particle 122 passing through the focal spot 116, rather than detecting different particles of the same analyte of interest. In such a case, according to act 318, the computing device apparatus may determine, based on executing software instructions, to increase the exposure time E to better match the transit time T and improve the SNR of each detection. Conversely, if the list of statistical results exhibits few “double detections” and more “single detections” than double detections (by way of a non-limiting example, if there were more than about 100 times more single detections than double detections), then the computing device apparatus executing act 318 may determine, based on executing software instructions, that the exposure time E is too long compared to the transit time T and thus reduce the exposure time E appropriately. In at least one other embodiment, the relative speed V and/or the focal spot size S may be adjusted or selected in response to the statistical analysis to achieve the preferred ratio between exposure time E and transit time T.

An alternative embodiment of method 300 may involve allowing the computing device 12, via executing software instructions, to gradually increase or decrease the exposure time E and evaluate the intensity of particle detections at each of a plurality of exposure times, and then select the exposure time E which produces the maximum intensity or maximum rate of distinct particle detections such as, but not limited to, situations where the exposure time E is selected such that there is a maximum rate of single detections and each consecutive “double detection” or “triple detection” is actually detected/counted as a single unique analyte particle, for example. In other embodiments, the relative speed V and/or the focal spot size S may be gradually changed in a similar manner as described for exposure time E to achieve the preferred rate of single detections or ratio of single detections to multiple detections.

Therefore, in at least one embodiment, the computing device 12, via executing software instructions, may be configured to vary at least one measurement parameter including: (a) the exposure time E; (b) the focal region size S; (c) the relative speed V; or (d) any operable combination of (a) to (c) by gradually increasing or decreasing the at least one measurement parameter to obtain a plurality of spectral data sets, evaluating an intensity of particle detections for each of the plurality of spectral data sets, and then selecting a desired value for the at least one measurement variable that produces a maximum intensity of distinct particle detections, a maximum rate of distinct particle detections, or more consecutive double detections than consecutive triple detections for the at least one analyte particle of interest.

In at least one embodiment, selecting the desired ratio between exposure time E and transit time T is generally achieved by selecting an exposure time E based on the transit time T, which is in turn a function of the particle size P, focal region size S, and relative speed of motion V.

Alternatively, in other embodiments, the systems and methods may be used to exploit the relationship between these variables in other ways. For example, the exposure time E may be set, and the relative speed V may be selected by controlling the motion of the sample 22 and/or the motion of the focal region in order to change the transit time T and the ratio between exposure time E and transit time T.

Alternatively, in at least one embodiment, the focal region size S may be selected in order to change the transit time T, using the relationships among particle size P, focal region size S, and relative speed V. By way of a non-limiting example, the focal region size S may be selected or changed by increasing or decreasing the focal length of the focusing lens 112 (by replacing it with a different lens, or using a liquid lens, zoom lens, or equivalent adjustable optical component for lens 112), changing the shape of lens 112 to create a larger aberrated spot, removing the lens 112 to permit the collimated beam 110 to illuminate the sample directly, adding one or more additional optical elements to the optical path (either before lens 112, after lens 112, or both) to change the effective focal length of the combined lens system or add or remove aberrations, or shift the position of lens 114 along the optical axis so that the focal region is deliberately defocused (and thus larger) upon a surface of the sample 22 or within a volume of the sample 22.

Additionally, in embodiments in which the sample 22 contains particles of more than one size, the size of the desired particles to be measured may be selected and the exposure time E and/or relative speed V may then be selected based on that selected particle size P to optimize the measurement of particles of that selected particle size, such that the desired ratio between exposure time E and transit time T is achieved for particles having the selected particle size which will therefore make a stronger contribution to the spectral data and analytical results than particles of larger or smaller sizes.

It should be noted that in each of the above embodiments, selecting an exposure time E, a focal region size S, a relative speed of motion V or any operable combination thereof is performed by configuring certain physical aspects of the optical, mechanical and/or electrical components of the systems described herein. A person skilled in the art will know how to configure one or more components of the systems described herein to achieve values of the exposure time E, the focal region size S, the relative speed of motion V or any operable combination thereof where the values are selected in accordance with the teachings herein. In contrast, the particle size P may be selected based on the measurements that are desired to be made.

The analysis of each Raman spectrum (represented by act 210 or act 310 in FIGS. 3A and 3B) may take one of several different forms. One example of an algorithmic approach is a univariate measurement of the Raman spectral data, typically by a computing device but alternatively employing another data processing mechanism such as, but not limited to, a server, a network appliance, an embedded device, a personal computer, a laptop, a personal data assistant, a smart-phone device, a tablet computer, or any other device capable of being configured to carry out the methods described herein, wherein the presence or quantity of the analyte particles of interest may be determined by the intensity value at a specific wavelength or wavenumber in the Raman spectrum which coincides with a spectral peak or band of the analyte particles of interest. Alternatively, the univariate measurement may be based on the difference of intensity between two locations in the spectrum (e.g., the spectral peak for the analyte particles of interest minus the flat region of spectral “background” that is near or adjacent to the analyte particles' spectral peak), or a peak area measurement that is summed over a region of the Raman spectrum representing a peak or band of the analyte of interest. In cases with multiple analyte types with different chemical compositions, the Raman peaks or bands for each analyte type may appear at different locations in the spectrum, and univariate measurements or tests specific to each analyte type may be performed in sequence or in parallel on the same spectrum.

Alternatively, in another example embodiment, acts 210/310 may utilize a multivariate algorithm such as PCA (principal component analysis), PLS (partial least squares), or other related technique including but not limited to: Multiple Linear Regression, Lasso Regression, Ridge Regression, K-Nearest Neighbours, Decision Trees, Random Forests, O-PLS, Support Vector Machines, Elastic Nets, Neural Networks, Linear Discriminant Analysis, or XGBoost. Any of these “chemometric” algorithms, which utilize a plurality of spectral data points from each Raman spectrum data set, may be implemented, as is known by those skilled in the art, via computer code on the computing device 12 or a separate computing device using any of the programming languages previously listed. In cases with multiple analyte types with different chemical compositions, the Raman peaks or bands for each analyte type may appear at different locations in the spectrum, and multivariate measurements or tests specific to each analyte type may be performed in sequence or in parallel on the same spectrum.

Alternatively, in another example embodiment, acts 210/310 may involve fitting the Raman spectral data with a theoretical curve or peak profile which represents the spectral signature of the analyte of interest. To determine the chemical concentration of the analyte of interest from each Raman spectral data set, a computing device may generate a simulated spectrum (by means of, for example but not limited to, one or more Gaussian, Lorentzian, or Voigt profiles; a spectral template measured empirically from a pure sample of the analyte of interest; or density functional theory) for each of a plurality of different chemical concentration levels, and then compare each of these theoretical spectra to the actual measured spectrum. When the computing device finds the theoretical spectrum which best matches the real spectrum, which may be assessed by the computing device executing software for a curve-matching algorithm such as classical least squares or maximum likelihood, for example, then the chemical concentration level corresponding to that best theoretical spectrum represents the best estimate of the chemical concentration of the analyte of interest in the region or volume of the sample being measured by that specific spectral data set. In cases with multiple analyte types with different chemical compositions, the Raman peaks or bands for each analyte type may appear at different locations in the spectrum, and curve or peak fitting measurements or tests specific to each analyte type may be performed in sequence or in parallel on the same spectrum.

In all such embodiments for acts 210/310, the result of the spectral analysis will be one or more numbers which express a quantity, score, concentration, or other value which represents the absence, presence, proportion, or quantity of one or more analytes of interest. In at least one embodiment, the methods 200/300 involve determining a relative proportion of the at least one analyte of interest in the inhomogeneous sample mixture via a statistical analysis of the set of analytical results.

To gain a statistically valid understanding of the properties of the sample as a whole, a plurality of results from analyses of individual spectra may be considered and evaluated. The number of results and the evaluation method that is used will depend on the type of information that one wishes to determine about the sample, so while there are no absolute guidelines, several example embodiments are described herein. Regarding the number of results, which are considered during acts 214 and 314 in FIGS. 3A and 3B, respectively, the number of independent measurement values in the cumulative list may be selected so as to form a valid statistical sample for a level of statistical confidence that is desired. By way of example, for a rough estimate of the concentration of the analyte of interest in the sample 22, one may accumulate the results from analysis of 10 consecutive spectra and then take the mean (average) value of the corresponding 10 concentration values. For instance, if the analysis of each spectrum involves determining whether the analyte of interest is present or absent, and analysis of 4 out of the 10 spectra show the presence of the analyte of interest, then one may conclude that the analyte of interest constitutes 40% of the sample mixture 22. However, with only 10 values, there is a large inherent statistical uncertainty in that conclusion, so for better confidence limits, a larger number of spectral analysis results may be collected, such as 100 results, 1,000 results, or 100,000 results depending on the situation. The reporting of each statistical analysis (act 216 or 316) will occur less frequently when more spectral analysis results are used per statistical analysis, but the conclusion from each report will be more statistically certain. Statistical approaches such as a running average (also called a boxcar average), Student's t-distribution, or a Kolmogorov-Smirnov distribution analysis may be utilized instead, in some cases, to determine a level of statistical confidence for each analytical result. If one needs to establish an upper limit on the presence of the analyte of interest (e.g., being 99% confident that a contaminant is not present above 100 parts per million) then other frequentist (e.g., traditional statistics) or Bayesian statistical methods may be employed.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

1. A method for performing spectroscopic measurement of at least one analyte of interest in an inhomogeneous sample using a spectroscopic system, wherein the method comprises:
generating and aiming an illumination beam which forms a focal region upon a surface of the sample or within a volume of the sample where there is relative motion between the sample and the focal region at a relative speed;
selecting a desired ratio between an exposure time for a detector of the spectroscopic system and a transit time for a particle of the at least one analyte of interest to traverse the focal region;
acquiring one or more spectral data sets corresponding to one or more spectra for a region of the sample within the focal region; and
analyzing the one or more spectral data sets to generate one or more corresponding analytical results.

2. The method of claim 1, wherein selecting the desired ratio between the exposure time and the transit time comprises selecting: (i) the exposure timed, (ii) the relative speed, (iii) a size of the focal region, or (iv) any combination thereof by configuring one or more elements of the spectroscopic system.

3. The method of claim 1, wherein the method comprises determining a relative proportion of the at least one analyte of interest in the sample via a statistical analysis of the one or more analytical results.

4. The method of claim 1, wherein the exposure time of the detector is in a range of one tenth of the transit time to ten times the transit time.

5. The method of claim 4, wherein the exposure time of the detector is selected to be equal to the transit time.

6. The method of claim 1, wherein the method comprises maintaining the focal region in a stationary position while the sample is moving past the focal region at the relative speed, maintaining the sample in a stationary position and moving the focal region across or through the sample at the relative speed or maintaining both the sample and the focal region in motion to produce the relative speed.

7. The method of claim 1, wherein the method comprises: (a) estimating, measuring, or selecting a size of the particle; and/or (b) estimating, measuring or selecting the relative speed for achieving the desired ratio between the exposure time and the transit time.

8. The method of claim 1, wherein the method comprises varying at least one measurement parameter including: (a1) the exposure time; (b1) a size of the focal region; (c1) the relative speed; or (d1) any combination of (a1) to (c1) by gradually increasing or decreasing the at least one measurement parameter to obtain a plurality of spectral data sets, evaluating an intensity of particle detections for each of the plurality of spectral data sets, and then selecting a desired value for the at least one measurement variable that produces a maximum intensity of distinct particle detections, a maximum rate of distinct particle detections, or more consecutive double detections than consecutive triple detections for the particle of the at least one analyte of interest.

9. The method of claim 1, wherein the analysis of each spectral data set is performed to detect a presence and/or concentration of the at least one analyte of interest in the sample.

10. The method of claim 1, wherein the spectroscopic system is configured to perform Raman spectroscopy, broadband ultraviolet spectroscopy, visible spectroscopy, near-infrared spectroscopy, infrared spectroscopy, fluorescence spectroscopy, or laser induced breakdown spectroscopy.

11. A spectroscopic system for performing spectroscopic measurement of at least one analyte of interest in an inhomogeneous sample, wherein the system comprises:
a light source for generating an illumination beam;
a sample measurement apparatus that is optically coupled to the light source for transmitting the illumination beam to form a focal region upon a surface of the sample or within a volume of the sample where the sample and the focal region move relative to one another at a relative speed;
a spectrometer that is optically coupled to the sample measurement apparatus for receiving light that is scattered, reflected, or emitted from the sample in response to the illumination beam; and
a computing device that includes at least one processor that is configured to execute software instructions causing the computing device to perform the spectroscopic measurement by:
selecting a desired ratio between an exposure time for a detector of the spectrometer and a transit time for a particle of the at least one analyte of interest to traverse the focal region;
acquiring one or more spectral data sets for a region of the sample within the focal region; and
analyzing the one or more spectral data sets to generate one or more corresponding analytical results.

12. The system of claim 11, wherein selecting the desired ratio between the exposure time and the transit time comprises selecting: (i) the exposure time, (ii) the relative speed, (iii) a size of the focal region, or (iv) any combination thereof by configuring one or more elements of the spectroscopic system.

13. The system of claim 11, wherein the computing device is configured to determine a relative proportion of the at least one analyte of interest in the sample via a statistical analysis of the one or more analytical results.

14. The system of claim 11, wherein the computing device configures the spectroscopic system such that the exposure time of the detector is in a range of one tenth of the transit time to ten times the transit time.

15. The system of claim 14, wherein the computing device configures the spectroscopic system such that the exposure time of the detector is equal to the transit time.

16. The system of claim 11, wherein the sample measurement apparatus is adapted to maintain the focal region in a stationary position and the sample is provided in a flow channel allowing the sample to move past the focal region at the relative speed, the sample is in a stationary position and the sample measurement apparatus is adapted to move the focal region across the sample at the relative speed or the sample measurement apparatus is adapted to move both the sample and the focal region to produce the relative speed.

17. The system of claim 11, wherein the computing device is configured to estimate, measure, or select a size of the particle; and/or estimate, measure or select the relative speed for achieving the desired ratio between the exposure time and the transit time.

18. The system of claim 11, wherein the computing device is configured to vary at least one measurement including: (a) the exposure time; (b) a size of the focal region; (c) the relative speed; or (d) any combination of (a) to (c) by gradually increasing or decreasing the at least one measurement parameter to obtain a plurality of spectral data sets, evaluate an intensity of particle detections for each of the plurality of spectral data sets, and then select a desired value for the at least one measurement variable that produces a maximum intensity of distinct particle detections, a maximum rate of distinct particle detections, or more consecutive double detections than consecutive triple detections for the particle of the at least one of interest.

19. The system of claim 11, wherein the computing device is configured to perform the analysis of each spectral data set to detect a presence and/or concentration of the at least one analyte of interest in the sample.

20. The system of claim 11, wherein the spectroscopic system is configured to perform Raman spectroscopy, broadband ultraviolet spectroscopy, visible spectroscopy, near-infrared spectroscopy, infrared spectroscopy, fluorescence spectroscopy, or laser induced breakdown spectroscopy.
